(19) United States
(12) Patent Application Publication
(10) Pub. No.: US 2024/0342893 A1
(43) Pub. Date: Oct. 17, 2024

(54) ROBOT SYSTEM

(71) Applicant: TOYOTA JIDOSHA KABUSHIKI KAISHA, Toyota-shi (JP)

(72) Inventors: Daiki FUKUNAGA, Toyota-shi (JP); Shiro ODA, Anjo-shi (JP); Takeshi MATSUI, Nissin-shi (JP)

(73) Assignee: TOYOTA JIDOSHA KABUSHIKI KAISHA, Toyota-shi (JP)

(21) Appl. No.: 18/594,162

(22) Filed: Mar. 4, 2024

(30) Foreign Application Priority Data
Apr. 17, 2023 (JP) 2023-067021

(51) Int. Cl. B25J 5/00; B25J 19/02; H02J 7/00

(52) U.S. Cl. CPC B25J 5/007; B25J 19/023; H02J 7/00

(57) ABSTRACT

A robot system includes a mobile robot. The mobile robot includes a power receiving pad and a sensor. The power receiving pad is configured to receive power supply from a power transmission pad of a charger. The sensor is disposed at a position displaced from the power receiving pad in an up-down direction, and configured to detect a surrounding object. The power receiving pad is provided as inclined in the up-down direction so as to project toward the sensor. The power transmission pad is provided as inclined in the up-down direction so as to face the power receiving pad. A distal end of the sensor on a side toward the power transmission pad is disposed on an outer side, in top view, with respect to the distal end of the power receiving pad.

### CROSS-REFERENCE TO RELATED APPLICATION

This application claims priority to Japanese Patent Application No. 2023-067021 filed on Apr. 17, 2023, incorporated herein by reference in its entirety.

### BACKGROUND

### 1. Technical Field

The present disclosure relates to a robot system.

### 2. Description of Related Art

Japanese Unexamined Patent Application Publication No. 2019-37435 (JP 2019-37435 A) discloses a non-contact power supply device that charges a robot in a cylindrical shape.

### SUMMARY

Such a mobile robot is occasionally provided with a contact sensor that detects contact with a surrounding object. When the contact sensor detects contact with a surrounding object, the mobile robot is stopped or decelerated. Such a sensor may be disposed on the outermost side of the mobile robot. Thus, the mobile robot may be stopped if the sensor contacts a charger when the mobile robot approaches the charger.

An aspect of the present embodiment provides a robot system including a mobile robot. The mobile robot includes a power receiving pad and a sensor. The power receiving pad is configured to receive power supply from a power transmission pad of a charger. The sensor is disposed at a position displaced from the power receiving pad in an up-down direction, and configured to detect a surrounding object. The power receiving pad is provided as inclined in the up-down direction so as to project toward the sensor. The power transmission pad is provided as inclined in the up-down direction so as to face the power receiving pad. A distal end of the sensor on a side toward the power transmission pad is disposed on an outer side, in top view, with respect to a distal end of the power receiving pad.

In the above robot system, the mobile robot may include an image capturing device. The sensor may be disposed between the image capturing device and the power receiving pad in the up-down direction.

In the above robot system, the charger may be provided with a label to be captured by the image capturing device. The mobile robot may be configured to approach the charger as the mobile robot travels rearward based on a captured image of the label.

In the above robot system, the sensor may be disposed at a position off a view angle of the image capturing device.

In the above robot system, the power receiving pad may be provided on a rear side in a moving direction of the mobile robot.

In the above robot system, the power receiving pad and the power transmission pad may be configured to perform non-contact charging.

The above robot system may further include the charger.

According to the present disclosure, it is possible to provide a robot system that can perform charging appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating the overall configuration of a mobile robot according to the present embodiment;

FIG. 2 is a perspective view illustrating a configuration in which a wagon is mounted on the mobile robot;

FIG. 3 is a side view schematically illustrating the system configuration to charge the mobile robot;

FIG. 4 is a side view illustrating the configuration of a power receiving portion as enlarged;

FIG. 5 is a schematic diagram illustrating the configuration of a power receiving pad and a sensor;

FIG. 6 is a schematic diagram illustrating the configuration of the power receiving pad and the sensor as vertically inverted;

FIG. 7 is a schematic diagram illustrating the view angle of a camera; and

FIG. 8 is a block diagram illustrating a control system for the mobile robot.

### DETAILED DESCRIPTION OF EMBODIMENTS

While the present disclosure will be described below by way of an embodiment, the claims are not limited to the following embodiment. All the components described in relation to the embodiment are not necessarily essential as means for solving the problem.

### First Embodiment

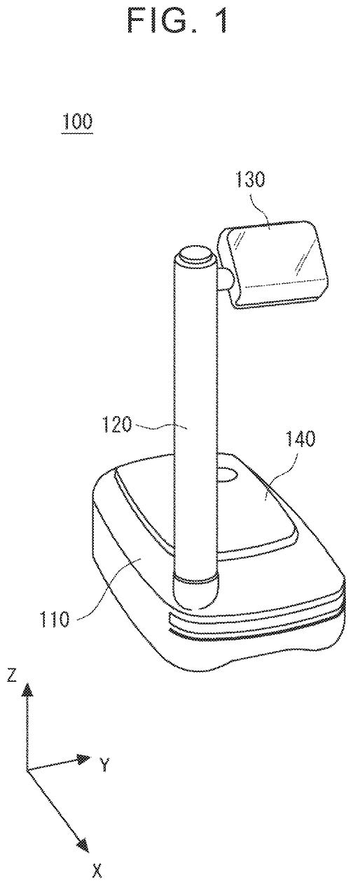

FIG. 1 is a perspective view illustrating the overall configuration of a mobile robot 100 according to the present embodiment. In the following description, an XYZ orthogonal coordinate system will be used as appropriate. An X direction is a front-rear direction of the mobile robot 100, a Y direction is a right-left direction, and a Z direction is a vertical up-down direction. More specifically, a +X direction is defined as a forward direction of the mobile robot 100, and a-X direction is defined as a rearward direction of the mobile robot 100. A+Y direction is a leftward direction of the mobile robot 100, and a −Y direction is a rightward direction of the mobile robot 100. A+Z direction is a vertically upward direction, and a −Z direction is a vertically downward direction.

The mobile robot 100 is movable in both the forward and rearward directions. That is, the mobile robot 100 moves in the forward direction when its wheels are rotated forward, and moves in the rearward direction when the wheels are rotated in reverse. Changing the rotational speed between the right and left wheels allows the mobile robot 100 to turn right or left.

The mobile robot 100 includes a platform 110, a stand 120, and an operation unit 130. The platform 110 is equipped with wheels, axles, a battery, a control computer, a drive motor, etc. The platform 110 rotatably holds the wheels (not illustrated in FIG. 1). The platform 110 may be provided with various sensors such as a camera and a distance measuring sensor. Herein, the mobile robot 100 will be described as an autonomous mobile robot. As a matter of course, the mobile robot 100 may be a mobile robot that moves according to operations by a user.

The platform 110 houses an elevation mechanism 140 for loading and unloading a load. The elevation mechanism 140 is disposed on the upper surface side of the platform 110. The elevation mechanism 140 is an elevation stage that can be elevated and lowered. The platform 110 is provided with a motor and a guide mechanism for elevation. The upper surface of the elevation mechanism 140 serves as a placement surface for placement of a wagon. The elevation mechanism 140 includes a lift mechanism that lifts the wagon. A space above the elevation mechanism 140 serves as a mounting space for mounting of the load. A chargeable secondary battery is mounted in the platform 110.

The stand 120 is attached to the platform 110. The stand 120 is a rod-shaped member that extends upward from the platform 110. Here, the stand 120 is formed in a circular column shape with its longitudinal direction corresponding to the Z direction. The longitudinal direction of the stand 120 is parallel to the Z direction. The stand 120 is disposed outside the elevation mechanism 140. That is, the stand 120 is disposed so as not to interfere with elevating and lowering operation of the elevation mechanism 140. The stand 120 is disposed on one end side of the platform 110 in the Y direction (right-left direction). The stand 120 is attached in the vicinity of the front right corner portion of the platform 110. The stand 120 is provided at an end portion of the platform 110 on the +X side and the −Y side in the XY plane.

The stand 120 supports the operation unit 130. The operation unit 130 is attached in the vicinity of the upper end of the stand 120. This allows the operation unit 130 to be installed at a height at which the operation unit 130 is easily operable by the user. That is, the stand 120 extends to a height at which the user standing can easily perform an operation. The operation unit 130 extends toward the +Y side from the stand 120. The operation unit 130 is disposed at the middle of the platform 110 in the right-left direction.

The operation unit 130 includes a touch panel monitor etc. that receives operations by the user. As a matter of course, the operation unit 130 may include a microphone etc. for audio input. The monitor of the operation unit 130 faces the opposite side of the platform 110. That is, a display surface (operation surface) of the operation unit 130 is a surface on the +X side. The operation unit 130 may be provided to be detachable from the stand 120. That is, a holder that holds a touch panel may be attached to the stand 120. The user can input a transport destination for a load, transport information about the load, etc. by operating the operation unit 130. Further, the operation unit 130 can display information such as the content of the load, the load expected to be transported, and the destination to the user during transport.

The user places a load (also referred to as an article or a transport object) in the wagon placed on the mobile robot 100, and requests transport. The mobile robot 100 autonomously moves to a set destination to transport the load. That is, the mobile robot 100 executes a transport task (hereinafter also referred to simply as a task) of transporting the load. In the following description, a location at which the load is mounted will be referred to as a transport origin or a loading location, and a location to which the load is delivered will be referred to as a transport destination or a destination.

For example, it is assumed that the mobile robot 100 moves in a general hospital with a plurality of clinical departments. The mobile robot 100 transports supplies, consumables, medical instruments, etc. among the clinical departments. For example, the mobile robot 100 delivers a load from a nurse station of a certain clinical department to a nurse station of another clinical department. Alternatively, the mobile robot 100 delivers a load from a storage for supplies and medical instruments to a nurse station of a clinical department. The mobile robot 100 also delivers medicine dispensed in a dispensing department to a clinical department or a patient expected to use the medicine.

Examples of the load include drugs, consumables such as bandages, specimens, inspection instruments, medical instruments, hospital diets, and supplies such as stationery. Examples of the medical instruments include sphygmomanometers, blood transfusion pumps, syringe pumps, foot pumps, nurse call buttons, bed leaving sensors, low-pressure continuous inhalers, electrocardiogram monitors, drug injection controllers, enteral nutrition pumps, artificial respirators, cuff pressure gauges, touch sensors, aspirators, nebulizers, pulse oximeters, artificial resuscitators, aseptic devices, and echo machines. Meals such as hospital diets and inspection diets may also be transported. The mobile robot 100 may further transport instruments that have been used, tableware that has been used, etc. When the transport destination is on a different floor, the mobile robot 100 may move using an elevator etc.

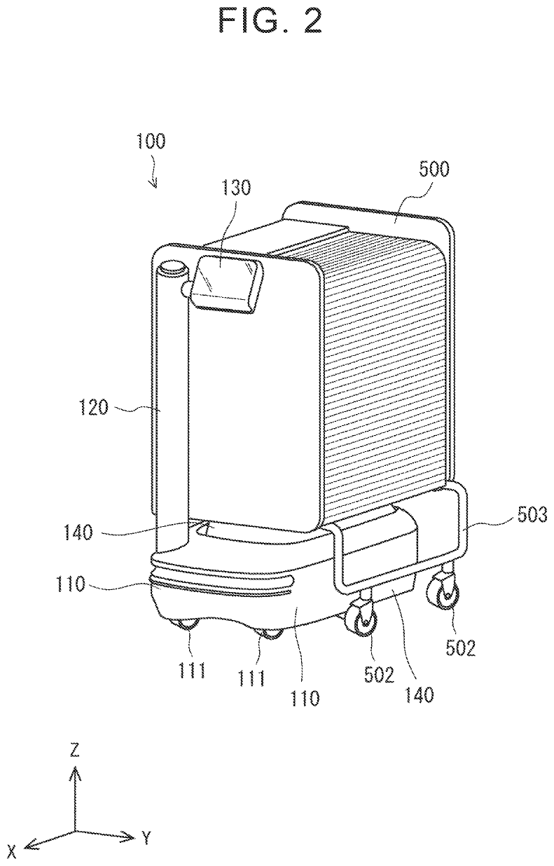

As illustrated in FIG. 2, the mobile robot 100 can hold the wagon 500 using the elevation mechanism 140. The wagon 500 houses a transport object. The wagon 500 is provided with wheels 502 and a frame 503. The wheels 502 are attached under the frame 503.

The frame 503 extends downward of the wagon 500. This allows a space for insertion of the platform 110 to be provided under the wagon 500. That is, the platform 110 can be inserted into the space directly under the wagon 500. When loading the wagon 500 onto the platform 110, the mobile robot 100 moves in the −X direction to enter the space directly under the wagon 500.

The wagon 500 can be loaded and unloaded by elevating and lowering the elevation mechanism 140. When the elevation mechanism 140 is elevated, the wagon 500 is lifted. That is, when the elevation mechanism 140 is elevated, the wagon 500 is mounted on the platform 110 with the wheels 502 brought off the ground. When the elevation mechanism 140 is lowered, the wheels 502 are brought into contact with the floor surface, and the upper surface of the elevation mechanism 140 is brought off the wagon 500. The wagon 500 is placed on the floor surface. The wagon 500 can be unmounted from the platform 110.

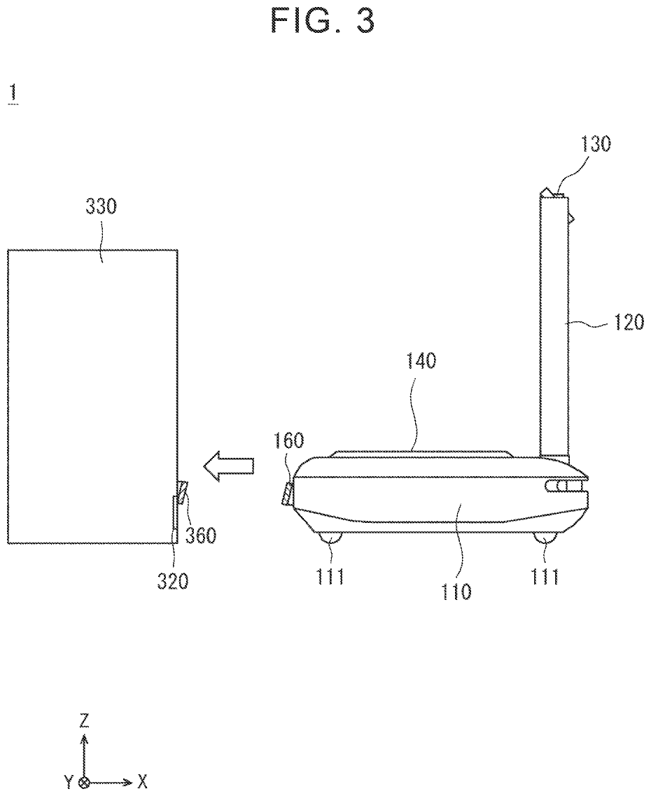

The platform 110 is provided with one or more wheels 111. For example, two wheels 111 are provided on the right and the left in FIG. 2, and two wheels 111 are provided on the front and the rear in FIG. 3. However, the number of wheels 111 is not specifically limited. For example, the mobile robot 100 may include four wheels, or may include six wheels. Further, the mobile robot 100 may include eight or more wheels. The mobile robot 100 may include one or more drive wheels to be rotated by a motor. Further, one or more of the wheels 111 may be driven wheels. The mobile robot 100 is moved along a desired route by controlling rotation of the wheels 111.

Next, a system configuration to charge the mobile robot 100 will be described with reference to FIG. 3. FIG. 3 is a side view schematically illustrating the configuration of a robot system 1 that includes the mobile robot 100. The robot system 1 is a robot charging system that includes the mobile robot 100 and a charger 300.

The mobile robot 100 includes a power receiving portion 160. The power receiving portion 160 is disposed at the rear end of the platform 110. The power receiving portion 160 is disposed to project rearward from the platform 110. The power receiving portion 160 includes a power receiving pad as discussed later. The platform 110 is provided with one or more wheels 111 to be driven by a battery built in the platform 110.

The charger 300 includes a power transmission portion 360, a label 320, and a housing 330. The charger 300 is installed in rear of the mobile robot 100. The housing 330 houses wires, a charging circuit, etc. (not illustrated). The housing 330 is provided with the power transmission portion 360 and the label 320. The power transmission portion 360 and the label 320 are disposed on a surface of the housing 330 on the mobile robot 100 side. The label 320 is formed on a surface of the housing 330 on the +X-side. The label 320 is formed on the outer surface of the housing 330 so as to be visually recognizable from the outside.

The label 320 may be painted or printed on the housing 330.

The power transmission portion 360 includes a power transmission pad as discussed later. The power transmission portion 360 is provided to project from the housing 330 toward the +X side. The power transmission portion 360 is provided at substantially the same height as the power receiving portion 160. The mobile robot 100 approaches the charger 300. The mobile robot 100 approaches the charger 300 while moving rearward. This enables the charger 300 to charge the battery of the mobile robot 100 with the power transmission pad and the power receiving pad facing each other. This allows the charger 300 to appropriately charge the mobile robot 100.

The mobile robot 100 moves toward the charger 300 by moving rearward.

When the mobile robot 100 moves to a position at which the power receiving portion 160 and the power transmission portion 360 face each other, the mobile robot 100 stops moving. The power receiving pad of the power receiving portion 160 and the power transmission pad of the power transmission portion 360 are of a non-contact charging type to perform charging in a non-contact manner. The charger 300 charges the mobile robot 100 with the power receiving portion 160 and the power transmission portion 360 facing each other.

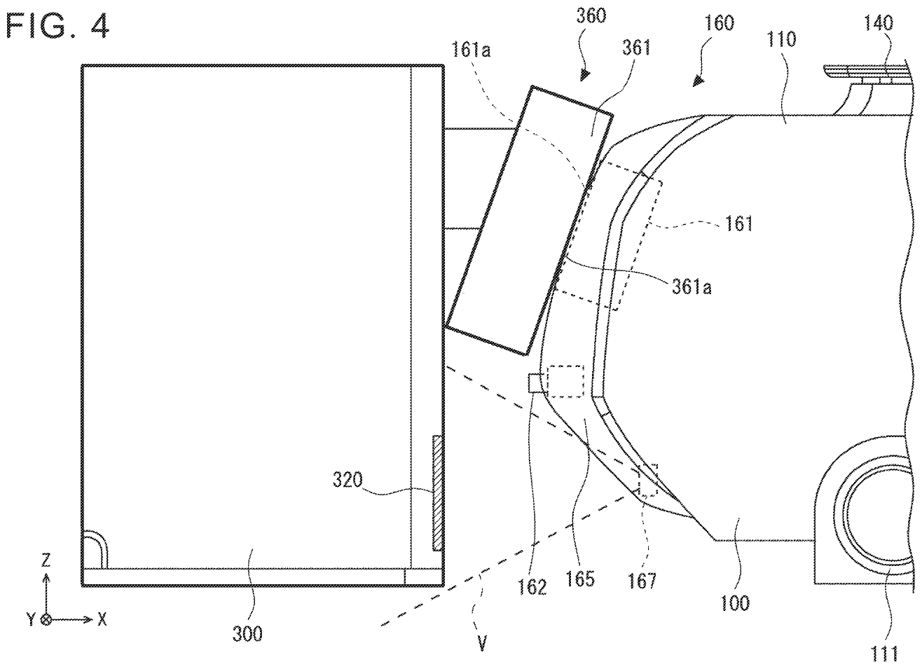

The configuration of the power receiving portion 160 and the power transmission portion 360 will be described with reference to FIG. 4. FIG. 4 is a side view illustrating the configuration of the power receiving portion 160 and the power transmission portion 360 as enlarged. FIG. 4 illustrates a state in which the mobile robot 100 is located at a charging position, that is, a state during charging.

As described above, the power receiving portion 160 is a portion of the platform 110 on the rear end side. The power receiving portion 160 includes a power receiving pad 161, a sensor 162, a cover 165, and a camera 167. The power transmission portion 360 includes a power transmission pad 361. The cover 165 is formed from a resin etc.

The power receiving pad 161 includes a built-in power receiving coil (not illustrated) etc. for non-contact charging. The power receiving pad 161 is attached to the platform 110 to face the −X side. The power transmission pad 361 is attached to the housing 330 to face the +X side. The power transmission pad 361 includes a built-in power transmission coil (not illustrated) etc. The power transmission pad 361 charges the mobile robot 100 via the power receiving pad. For example, the power transmission coil of the power transmission pad 361 and the power receiving coil of the power receiving pad 161 are inductively coupled to each other.

A surface of the power receiving pad 161 on the power transmission pad 361 side is defined as a power receiving surface 161a. The power receiving surface 161a is disposed to face the −X side. A side surface of the power receiving pad 161 is covered by the cover 165. The power receiving surface 161a of the power receiving pad 161 may be exposed from the cover 165. A surface of the power transmission pad 361 on the power receiving pad 161 side is defined as a power transmission surface 361a. The power transmission surface 361a is disposed to face the +X side.

The power receiving surface 161a is inclined so as to be directed upward. The power transmission surface 361a is inclined so as to be directed downward. The power receiving surface 161a and the power transmission surface 361a are formed as parallel surfaces. The power transmission coil and the power receiving coil are disposed in proximity to each other when the power receiving surface 161a and the power transmission surface 361a face each other. The charger 300 charges the mobile robot 100 with the power receiving surface 161a and the power transmission surface 361a in contact with or in proximity to each other, for example. The power receiving pad 161 receives power supply from the power transmission pad 361 provided on the charger 300.

The sensor 162 is provided below the power receiving pad 161. The distal end of the sensor 162 projects from the cover 165. That is, the sensor 162 is disposed so as to protrude from the cover 165 toward the −X side. The sensor 162 is preferably disposed on the outermost side. For example, the sensor 162 projects rearward from the platform 110.

The sensor 162 detects another object (hereinafter also referred to as a surrounding object) located in the surroundings. When the sensor 162 detects a surrounding object, the mobile robot 100 is stopped or decelerated. The distal end of the sensor 162 is disposed on the −X side with respect to the power receiving pad 161. The distal end of the sensor 162 is disposed on the rear side with respect to the power receiving pad 161. The sensor 162 is disposed at a position lower than the power transmission pad 361. The sensor 162 is positioned below the power transmission pad 361.

The sensor 162 is a contact sensor that detects contact with a surrounding object, for example. When the sensor 162 abuts against a surrounding object, the distal end of the sensor 162 is slid. Alternatively, the sensor 162 may be expanded, contracted, or deformed by contact with a surrounding object. This allows the sensor 162 to detect the surrounding object. Alternatively, the sensor 162 may be a proximity sensor that detects approach of a surrounding object according to a change in capacitance or a change in magnetic field. Alternatively, the sensor 162 may be an optical sensor such as a camera or an image acquisition sensor.

When the sensor 162 detects a surrounding object, the mobile robot 100 is stopped. This makes it possible to mitigate an impact due to contact with the surrounding object, or avoid contact with the surrounding object. Since the sensor 162 is disposed on the outermost side of the platform 110, contact with the surrounding object can be detected appropriately. This enables safer movement.

As described above, the mobile robot 100 includes a power receiving pad 161 and a sensor 162 that detects a surrounding object. The sensor 162 is disposed at a position displaced from the power receiving pad in the up-down direction. The power receiving pad 161 is provided as inclined in the up-down direction so as to project toward the sensor 162. The power transmission pad 361 is provided as inclined in the up-down direction so as to face the power receiving pad 161. The distal end of the sensor 162 is disposed on the outer side with respect to the distal end of the power receiving pad 161. This makes it possible to suppress contact of the sensor 162 with the charger 300 while approaching the charging position. Hence, the mobile robot 100 can be immediately moved to an appropriate charging position. The charger 300 can appropriately charge the mobile robot 100.

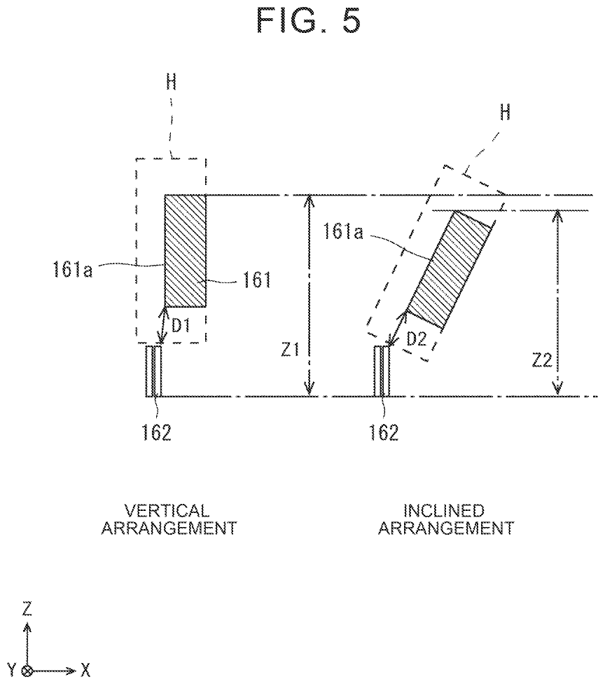

Such an inclined arrangement makes it possible to efficiently use the space. This respect will be described with reference to FIG. 5. FIG. 5 schematically illustrates the power receiving pad 161 and the sensor 162. FIG. 5 illustrates the power receiving pad 161 in a vertical arrangement and the power receiving pad 161 in an inclined arrangement. In FIG. 5, the components are simplified as appropriate. For example, the charger 300 is not illustrated in FIG. 5.

In the inclined arrangement, the power receiving pad 161 is inclined in the up-down direction such that the power receiving surface 161a is directed upward. That is, in the inclined arrangement, the power receiving surface 161a is not parallel to the YZ plane. In the vertical arrangement, the power receiving surface 161a is not inclined in the up-down direction. That is, in the vertical arrangement, the power receiving surface 161a is parallel to the YZ plane.

In the case of non-contact charging of an electromagnetic induction type, and if there is metal around the power receiving pad 161, the metal is inductively heated. In FIG. 5, an area in which the power receiving pad 161 may heat metal is indicated as a heating area H. If a metal structure member is disposed in the heating area H, the metal structure member may be heated. When the sensor 162 includes a metal structure member, the sensor 162 is preferably disposed outside the heating area H.

The mobile robot 100 approaches the charger 300 with the power receiving pad 161 disposed on the charger 300 side of the mobile robot 100. When non-contact power transmission and receiving pads are brought into proximity to each other, the space in the up-down direction can be used efficiently by disposing the power receiving pad 161 in the inclined arrangement. In other words, the vertical arrangement requires a large space in the up-down direction compared to the inclined arrangement. Since the power receiving pad 161 for non-contact charging and the sensor 162 can be brought as close as possible to each other, a space-saving layout can be achieved.

Inclining the power receiving pad 161 in the up-down direction can increase the distance to the sensor 162 as illustrated in FIG. 5. For example, the distance between the power receiving pad 161 and the sensor 162 in the vertical arrangement is defined as D1, and the distance between the power receiving pad 161 and the sensor 162 in the inclined arrangement is defined as D2. The distance D2 is longer than the distance D1. The total size of the power receiving pad 161 and the sensor 162 can be reduced in the Z direction. The upper end of the power receiving pad 161 in the vertical arrangement is positioned to be higher than the upper end of the power receiving pad 161 in the inclined arrangement. A size Z2 in the Z direction in the inclined arrangement is smaller than a size Z1 in the Z direction in the vertical arrangement. The sensor 162 and the power receiving pad 161 can be mounted on the platform 110 in a space-saving arrangement, reducing the size of the platform 110. In the inclined arrangement, the thickness of the platform 110 can be reduced compared to the vertical arrangement. The inclined arrangement can lower the surface in which the elevation mechanism 140 is mounted, increasing the loading capacity of the wagon 500. A sufficient loading capacity can be secured even in a facility with a height limit for the wagon 500.

In top view, the distal end (on the −X side) of the sensor 162 on the side toward the power transmission pad 361 side (i.e. −X side) is disposed on the outer side with respect to the distal end (on the −X side) of the power receiving pad 161. In top view, the outer edge of the sensor is located on the outer side in the radial direction of the robot with respect to the outer edge of the power receiving pad 161. The distal end of the sensor 162 on the −X side is located on the −X side with respect to the distal end of the power receiving pad 161 on the −X side.

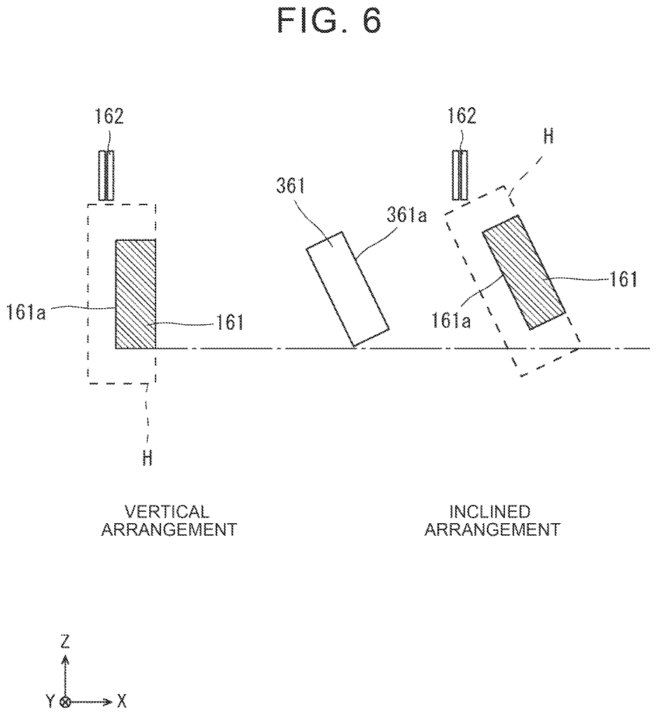

While the power receiving pad 161 is disposed above the sensor 162 in FIGS. 4 and 5, the power receiving pad 161 may be disposed below the sensor 162 as illustrated in FIG. 6. In this case, the direction of inclination of the power receiving pad 161 and the power transmission pad 361 in the vertical direction may be inverted. That is, the power receiving pad 161 may be inclined to face downward, and the power transmission pad 361 may be inclined to face upward. The lower end of the power receiving pad 161 in the vertical arrangement is positioned to be lower than the lower end of the power receiving pad 161 in the inclined arrangement. Also with this configuration, the space can be used efficiently in the up-down direction.

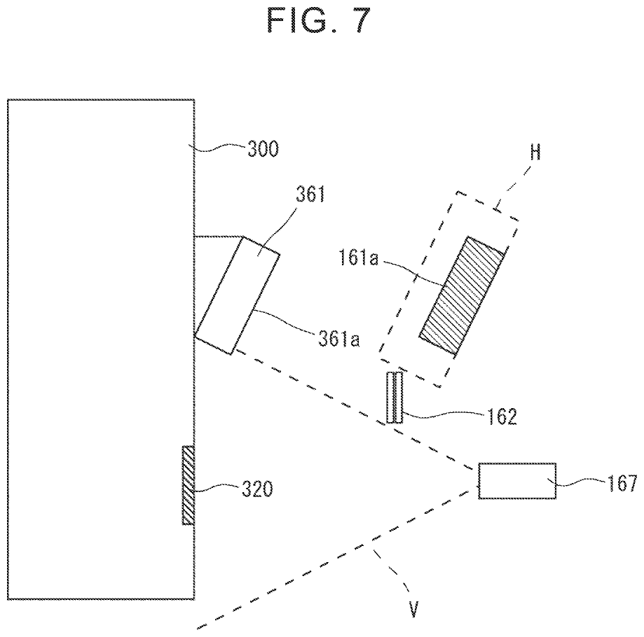

As illustrated in FIG. 4, further, the camera 167 is provided below the sensor 162. The camera 167 is an image capturing device such as a charge-coupled device (CCD) camera and a complementary metal oxide semiconductor (CMOS) sensor. The camera 167 is disposed to face rearward. A side surface of the camera 167 may be covered by the cover 165. The rear side of the camera 167 is not covered by the cover 165. The cover 165 is off a view angle V of the camera 167. The camera 167 captures an image of the label 320. As illustrated in FIG. 7, the label 320 is included in the view angle V of the camera 167. Here, the camera 167 is disposed at the same height as the label 320.

The label 320 includes characters, a figure, a QR code (registered trademark), etc., and is used for positioning. That is, the label 320 is provided in order to detect the position of the mobile robot 100 relative to the charger 300. The mobile robot 100 is controlled so as to move based on a captured image of the label 320. The mobile robot 100 approaches the charger 300 as the mobile robot 100 travels rearward based on the captured image of the label 320. This allows the charger 300 to appropriately charge the mobile robot 100.

For example, the camera 167 captures an image of the label 320 at an appropriate charging position. The image of the label 320 captured at an appropriate charging position is defined as a reference image. The power receiving pad 161 approaches the power transmission pad 361 as the mobile robot 100 moves based on the reference image. The mobile robot 100 retracts such that the captured image of the label 320 becomes closer to the reference image. This allows the mobile robot 100 to move to an appropriate charging position.

The camera 167 is disposed on the +X side with respect to the sensor 162. The sensor 162 and the power receiving pad 161 are disposed at positions not included in the view angle V of the camera 167. That is, the sensor 162 and the power receiving pad 161 are disposed at positions off the view angle V of the camera 167. This allows the camera 167 to appropriately capture an image of the label 320, allowing the mobile robot 100 to move to an appropriate charging position. Hence, a charging error etc. due to displacement etc. can be suppressed.

Here, the sensor 162 is disposed between the camera 167 and the power receiving pad 161 in the up-down direction. While the camera 167 is disposed below the sensor 162, the position of the camera 167 is not specifically limited. For example, the camera 167 may be disposed at a side or above the sensor 162.

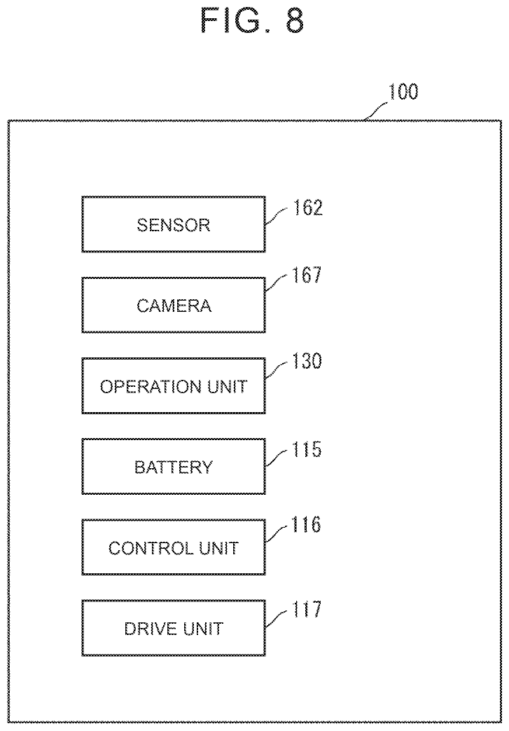

Next, a control system for the mobile robot 100 will be described with reference to FIG. 8. FIG. 8 is a block diagram illustrating the control system for the mobile robot 100. The mobile robot 100 includes a battery 115, a control unit 116, a drive unit 117, the operation unit 130, the sensor 162, and the camera 167.

As described above, the battery 115 is a rechargeable secondary battery, and supplies power to the constituent elements. The drive unit 117 includes a motor, a brake, etc. for driving the wheels 111 (see FIG. 2). The control unit 116 includes a processor, a memory, etc., and controls the constituent elements according to a computer program. The control unit 116 outputs a command for controlling the drive unit 117. The operation unit 130, the control unit 116, and the drive unit 117 are supplied with power from the battery 115.

For example, the control unit 116 includes a memory that stores map information on a facility. When the user inputs a destination on a map by operating the operation unit 130, the control unit 116 searches for a route to the destination by referencing the map information. Then, the control unit 116 outputs a command for driving the wheels 111 to the drive unit 117. This causes the motor of the drive unit 117 to rotate the right and left wheels 111, moving the mobile robot 100 along the route.

The sensor 162 and the camera 167 are supplied with power from the battery 115. The sensor 162 detects a surrounding object as described above. When the sensor 162 detects a surrounding object, the control unit 116 outputs a command to the drive unit 117. This causes the mobile robot 100 to be stopped or decelerated. The mobile robot 100 may include a plurality of sensors 162. For example, the sensor 162 may be provided at each of the front, rear, right, and left of the platform 110. The mobile robot 100 is stopped or decelerated no matter which of the front, rear, right, and left directions a surrounding object approaches the mobile robot 100 from.

Further, the control unit 116 controls the drive unit 117 so as to move to the charger 300 when the remaining capacity of the battery 115 becomes a predetermined value or less. The camera 167 captures an image of the label 320 of the charger 300 on the way to the charger 300. When the camera 167 captures an image of the label 320, the control unit 116 controls the drive unit 117 based on the captured image of the label 320. This allows the mobile robot 100 to immediately move to an appropriate charging position. The control unit 116 can detect the position of the mobile robot 100 relative to the charger 300 based on the captured image. Hence, the mobile robot 100 can be moved to the charging position with high positional precision.

The battery 115 is supplied with power from the power transmission pad 361 via the power receiving pad 161. The charger 300 charges the battery 115 in a non-contact manner. The control unit 116 may use a machine learning model such as deep learning in searching for a route or controlling the drive unit 117.

A part or all of the processes in the mobile robot 100 etc. discussed above can be implemented as a computer program. Such a program can be stored using various types of non-transitory computer-readable media, and supplied to a computer. The non-transitory computer-readable media include various types of tangible storage media. Examples of the non-transitory computer-readable media include magnetic storage media (e.g. flexible disks, magnetic tapes, and hard disk drives), magneto-optical storage media (e.g. magneto-optical disks), compact disc (CD) read only memory (ROM), compact disc recordable (CD-R), compact disc rewritable (CD-R/W), and semiconductor memory (e.g. mask ROM, programmable ROM (PROM), erasable PROM (EPROM), flash ROM, and random access memory (RAM)). Alternatively, the program may be supplied to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber or a wireless communication path.

The present disclosure is not limited to the above embodiment, and can be modified as appropriate without departing from the spirit and scope of the present disclosure. For example, while a system in which a mobile robot autonomously moves in a hospital has been described in relation to the embodiment discussed above, the system discussed above can transport a predetermined article as a load in hotels, restaurants, office buildings, event sites, or complex facilities.

The present disclosure is not limited to the above embodiment, and can be modified as appropriate without departing from the spirit and scope of the present disclosure.

What is claimed is:

1. A robot system comprising a mobile robot, wherein:
the mobile robot includes a power receiving pad and a sensor;
the power receiving pad is configured to receive power supply from a power transmission pad of a charger; the sensor is disposed at a position displaced from the power receiving pad in an up-down direction, and configured to detect a surrounding object;
the power receiving pad is provided as inclined in the up-down direction so as to project toward the sensor;
the power transmission pad is provided as inclined in the up-down direction so as to face the power receiving pad; and
a distal end of the sensor on a side toward the power transmission pad is disposed on an outer side, in top view, with respect to a distal end of the power receiving pad.

2. The robot system according to claim 1, wherein:
the mobile robot includes an image capturing device; and
the sensor is disposed between the image capturing device and the power receiving pad in the up-down direction.

3. The robot system according to claim 2, wherein:
the charger is provided with a label to be captured by the image capturing device; and
the mobile robot is configured to approach the charger as the mobile robot travels rearward based on a captured image of the label.

4. The robot system according to claim 2, wherein the sensor is disposed at a position off a view angle of the image capturing device.

5. The robot system according to claim 2, wherein the power receiving pad is provided on a rear side in a moving direction of the mobile robot.

6. The robot system according to claim 1, wherein the power receiving pad and the power transmission pad are configured to perform non-contact charging.

7. The robot system according to claim 1, further comprising the charger.
